(19) United States
(12) Patent Application Publication
(10) Pub. No.: US 2002/0038518 A1
(43) Pub. Date: Apr. 4, 2002

(54) Layout system and method used in the erection of building structures

(76) Inventor: John Barrows, Falmouth, ME (US)

Correspondence Address: DICKSTEIN SHAPIRO MORIN & OSHINSKY LLP, 2101 L STREET NW, WASHINGTON, DC, 20037-1526, US

(21) Appl. No.: 09/848,346

(22) Filed: May 4, 2001

Related U.S. Application Data
(60) Provisional application No. 60/236,745, filed on Oct. 2, 2000.

(51) Int. Cl. G01B 3/10

(52) U.S. Cl. 33/758

(57) ABSTRACT

A system for providing information to construction personnel directly on the building components is described. In one aspect, this system includes a tape providing preprinted sets of information. Some of the sets of information provide accurate positioning information for construction elements, while other sets of information specify the exact construction element to be placed at a specific location. The tape may be placed along a bearing face or top plate of framing for the building structure under construction. The tape may have an adherent surface which enables the tape to be immovably placed upon the bearing face.

This application claims priority from provisional application serial No. 60/236,745, filed Oct. 2, 2000, which is incorporated herein by reference in its entirety.

### FIELD OF THE INVENTION

The invention generally relates to an apparatus and a methodology for providing accurate and easily recognizable information useful in the construction of buildings. In particular, the invention relates to an apparatus and method for providing positioning information, and other data, for proper positioning of trusses, beams, joists, girders and conventional framing.

### BACKGROUND

Conventional methods for construction of a building structure include utilizing a blueprint plan, which shows overall dimensions for the structure as well as a start point for positioning various construction components, at the construction site. There are numerous disadvantages to this conventional approach. One disadvantage is that the construction personnel must measure to determine where various construction elements should be positioned along the building framing. In addition to being a time consuming task, there is a possibility that the measurements made may be inaccurate.

A further disadvantage is that the blueprint plan has small scale numbers which may be hard to read or confusing. Further, the plan may have a portion or portions which are not completely legible, leaving the construction personnel at the construction site to guess at what such portions indicate or to halt work and communicate with the architect. Guessing at what some portions of a blueprint indicate may lead to error in the construction of the structure, and halting work until the architect advises what the portion indicates leads to a longer construction time and greater expense.

In addition, the blueprint plan is generally kept with the construction foreman in a trailer or other building on the construction site, and so is not readily accessible to the construction personnel actually constructing the structure. Since the blueprint plan is remote to the actual construction, error in the construction may occur due to the construction personnel misinterpreting the foreman's instructions or incorrectly remembering what the blueprint plan indicates.

Therefore, a need exists for an improved method for erecting a building structure which diminishes the possibility of the occurrence of one or more of the above-noted disadvantages of the conventional methods.

### SUMMARY

The disadvantages of the prior art are alleviated to a great extent by the invention which provides a system for positioning construction elements. The system includes a first set of information which has a start indicator that indicates a position of a first construction element with which the start indicator is to be aligned and at least one marker that indicates a position and alignment of at least one other construction element. In one aspect, the system includes a tape.

In a preferred embodiment, the invention provides a tape for positioning construction elements that includes a set of information having at least one marker that indicates a position and alignment of at least one construction element and identification data that identifies the construction element, and at least one adherent surface for adhering the tape to at least one construction element.

The invention further provides an apparatus for positioning construction elements including a tape. The tape includes a start indicator corresponding to a starting location on a first construction element, a plurality of markers each indicating a position and alignment of one of a respective plurality of construction elements, measurement data that indicates a distance of each of the plurality of markers from the start indicator, identification data that identifies each of the plurality of construction elements, and at least one adherent surface that causes at least the tape to adhere to at least one of the plurality of construction elements.

The invention further provides a construction method that includes the steps of:

a) providing at least first and second positional indicators on a tape, the first positional indicator corresponding to a first location on a first construction element from which at least the second positional indicator corresponding to at least a second construction element is measured, and the second positional indicator corresponding to a second location at which at least the second construction element is to be positioned and aligned; and

b) attaching the tape to at least one construction element.

These and other advantages and features of the invention will be more readily understood from the following detailed description which is provided in connection with the accompanying drawings.

### BRIEF DESCRIPTION OF THE DRAWINGS

FIG. 1 is a top view of a building under construction utilizing a tape constructed in accordance with an embodiment of the invention.

FIG. 2 is a perspective view showing a tape used in the erection of building components.

FIG. 3 is a top view of a tape.

### DETAILED DESCRIPTION OF PREFERRED EMBODIMENTS

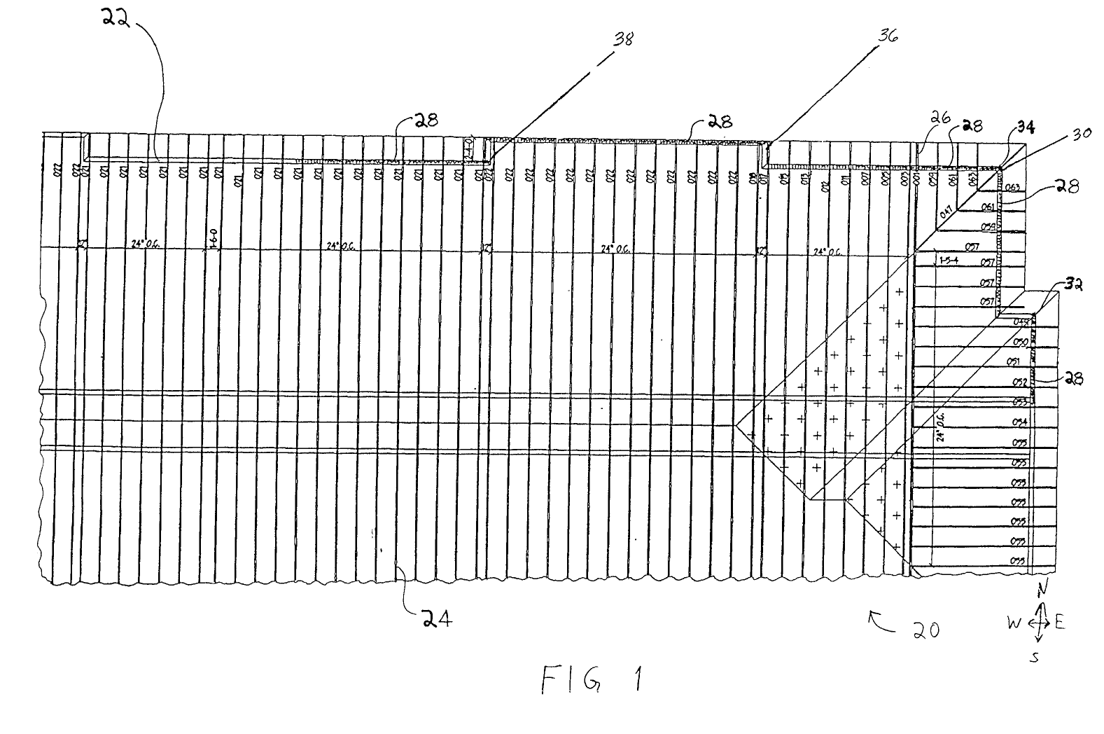

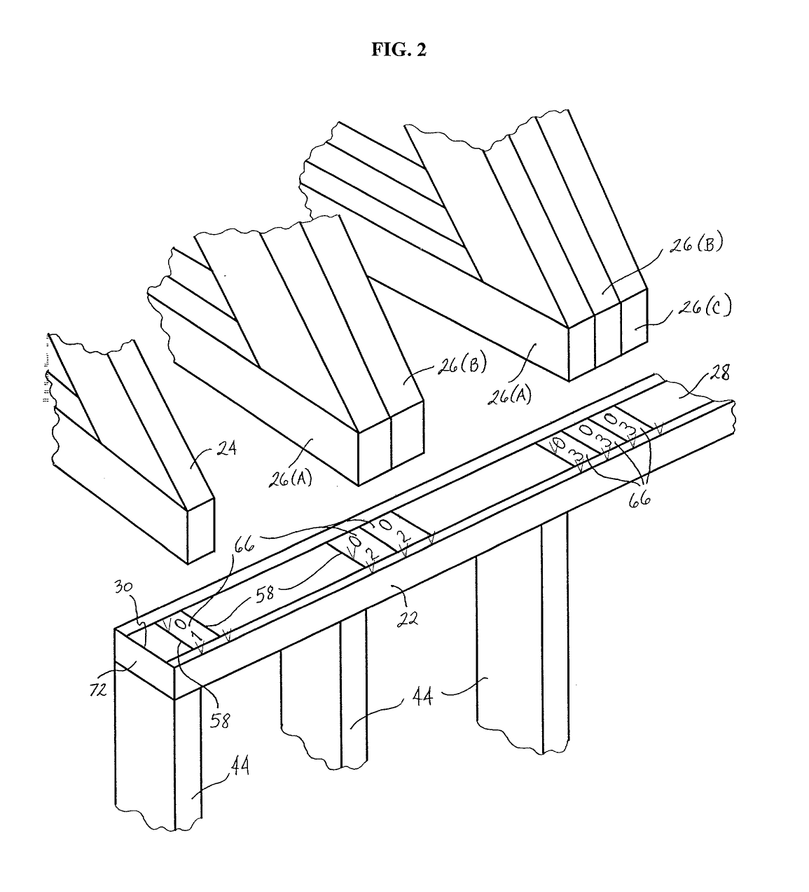

Referring now to FIGS. 1-3, a structural layout 20 is shown which indicates the placement and positioning of first construction elements 22, second construction elements 24, and third construction elements 26. The first construction elements 22 may be the top plates or bearing faces of the building framing supported by studs 44 (FIG. 2). The second construction elements 24 may be trusses, beams, joists, girders or other forms of conventional framing. The third construction elements 26 may be trusses, beams, joists, girders or other forms of conventional framing formed of two or more plies of such framing. For example, a two-ply truss 26 includes truss plies 26(A), 26(B), and a three-ply truss 26, includes truss plies 26(A), 26(B), and 26(C) (FIG. 2).

Positioned on the bearing face of the framing 22 is an information system. In a preferred embodiment, the system is in the form of a tape 28. Although the system shall be described with reference to the tape 28, the system can take other forms suitable for conveying information accurately and easily to the construction personnel directly at the construction site.

The tape 28 preferably is to be attached on a bearing face of the frame 22. A preferred method of attaching the tape 28 to the framing 22 is through adhesives. Specifically, the tape 28 may include an adherent surface 50 which enables the tape 28 to be placed on the framing 22 and held there. Alternatively, the tape 28 may be a strip of material attached to the framing 22 via other attachment mechanisms, such as, for example, staples, nails, brads, screws, cable, wire, string, or other like attachment mechanisms. The tape 28 preferably is formed of a material which is weather resistant, such as, for example, a synthetic or polycarbon fiber reinforced tape which is resistant to the effects of temperature and/or moisture. The tape 28 may further be formed of a material which provides the tape 28 a surface which has a high coefficient of friction, thereby rendering the tape 28 generally non-slip. The tape 28 may take any dimensions, but it is preferably about three inches in width, thereby ensuring a proper fit on the face of a two by four.

The tape 28 includes a variety of information and/or instructions relating to., among other things, positioning data. As shown in FIG. 1, the framing 22 extends in the north to south direction and in the east to west direction, and so consequently does the tape 28. The tape 28 which extends in a north to south direction has a start point 30. Since the framing 22 does not extend solely in a north to south direction along the entire extent of the right hand side of the structural layout 20, the tape 28 includes a first rest art point 32. The start point 30 corresponds to and is meant to be aligned with a start indicator 72 (FIG. 2) on the framing 22.

Similarly, the tape 28 extending in an east to west direction has a start point 34. As with the framing 22 extending in a north to south direction, the framing 22 extending in the east to west direction does so discontinuously, and so the tape 28 includes a first restart point 36 and a second restart point 38. The restart points 32, 36, 38 provide easy reference points for construction personnel, as do the start points 30, 34. Additionally, the restart points 32, 36, 38 and the start points 30, 34 ensure that accurate spacing and positioning of the various construction elements 24 is maintained for the building structure under construction.

It will be noted with reference to FIG. 1 that not all of the construction elements 24 end flush with the framing 22, but instead overhang the framing 22. The tape may include pertinent instructions and/or information on any individual construction element 24 such as, for example, “Field cut overhang as required” or “Refer to structural details”.

The tape 28 includes a variety of sets of information and/or data which can be used by personnel erecting the building structure to quickly and accurately match up aid position specific construction elements on the framing 22, as well as provide other useful information. The information provided in the sets of information on the tape 28 is preprinted for each specific construction job, and thus all that is necessary to begin erecting the structure is putting up the framing 22 and attaching the tape 28 to the framing.

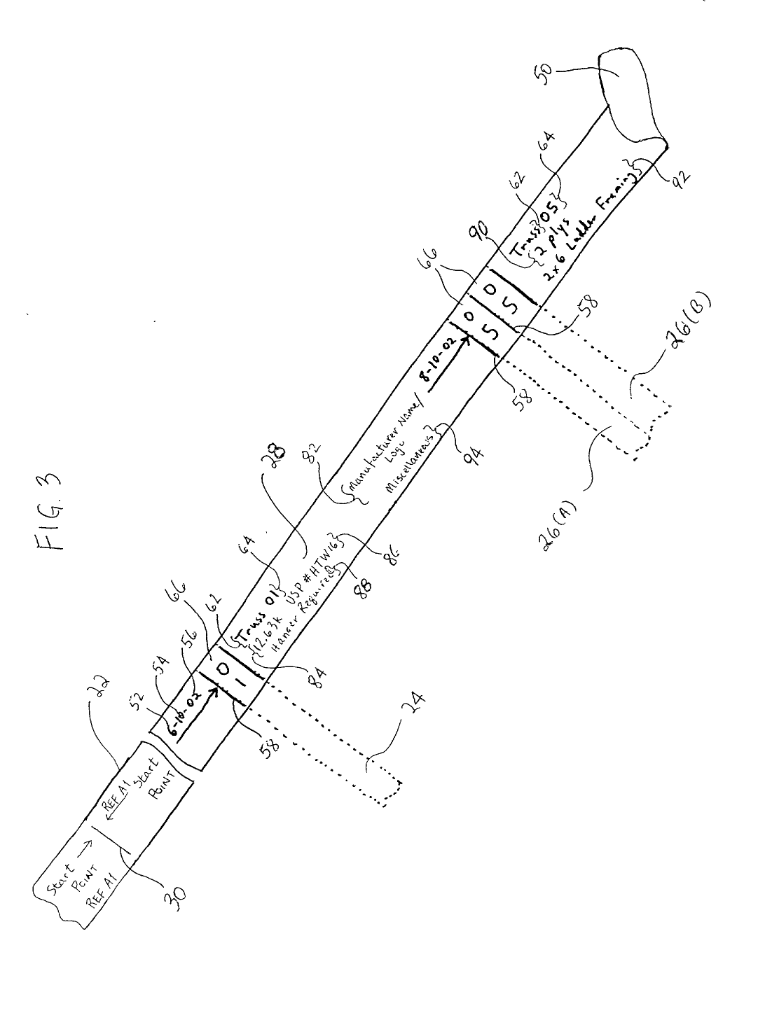

Spaced along the tape 28 is a set of information providing the aggregate distance between the start point 30 and a construction element positional indicator 58. Preferably, the aggregate distance information is separated into a feet component 52, an inches component 54, and a sixteenths component 56. For example, the construction element positional indicator 58 on the left hand side of FIG. 3 is shown to be six feet, ten inches and two-sixteenths from the start point 30 through the distance information 6-10-02 which correspond to the three components 52, 54, 56.

The construction element positional indicator 58 indicates the proposed position and alignment of a particular construction element. The specific construction element 24 is determined through a construction element identifier module 66. Each construction element 24 may be marked with a corresponding identifier. Furthermore, adjacent the construction element identifier module 66 on the tape 28 is a construction element type module 62 and a construction element number module 64. According to FIG. 3, the construction element to be positioned at the construction element positional indicator 58 on the left hand side of the figure is a truss labeled 01, while the construction element to be positioned at the construction element positional indicator 58 on the right hand side is a truss labeled 05. Thus, from the modules 62, 64, 66, it is a simple matter for construction personnel to locate the appropriate construction element 24 for alignment with the appropriate construction element positional indicator 58.

Other sets of information positioned on the tape 28 include a job information set 82, which provides the name and/or logo of the manufacturer, fabricator, and/or distributor of the construction elements 24, and a loading information set 84, which provides the loading requirements of the construction element 24 to be positioned adjacent to the module 84. Additional information is contained in a USP information set 86, a construction element requirements set 88, a ply information set 90, a framing information set 92, and a miscellaneous information set 94. As shown in FIG. 3, the information set 86 shows the USP number to be HTW16 which provides construction personnel with the instruction that, while there are a variety of options for attaching the particular construction element 24, a specific piece of hardware (in this case part number HTW16) is to be used. The information set 88 indicates that a hanger is required for positioning the construction element 24 (in this instance Truss 01) on the framing 22. Also, the information set 90 shows that a two-ply construction element (in this instance Truss 05) is to be used, and the information set 94 provides the information that a two by six framing construction is required at that position.

The above description and drawings are only illustrative of certain preferred versions which achieve the objects, features and advantages of the present invention. It is not intended that the present invention be limited to these versions. For example, while the tape 28 is shown on the bearing face of the framing 22, there may be instances where the tape 28 can be placed in another location on the framing 22, such as on a side face or a back face of the framing 22. Additionally, while the information provided on the tape 28 in the various sets of information is represented either alphabetically or numerically, numerical information may instead be represented alphabetically, and alphabetically represented information may be represented numerically. Further, all such information provided may instead be represented symbolically. Also, while the system has been described in terms of the tape 28, the system may take other forms. For example, information sets can be added directly to the framing, or the sets of information can be included on other media, such as, for example, cloth strips, thin metallic plates or sheets, or thin wood layers. Accordingly, the invention is not to be seen as limited by the foregoing description, but is only limited by the scope of the appended claims.

What is claimed as new and desired to be protected by a Letters Patent of the United States:

1. A system for positioning construction elements, comprising a first set of information which includes a start indicator indicating a position of a first construction element with which said start indicator is to be aligned and at least one marker that indicates a position and alignment of at least one other construction element.

2. The system of claim 1, wherein the system comprises a tape.

3. The system of claim 2, wherein the tape includes at least one adherent surface for adhering the tape to said first construction element.

4. The system of claim 1, further comprising a second set of information which includes a construction element identifier.

5. The system of claim 2, wherein said tape is sized and configured to be positioned on a bearing face of said first construction element.

6. A tape for positioning construction elements, comprising:
at least one set of information having at least one marker that indicates a position and alignment of at least one construction element and identification data that identifies said construction element; and
at least one adherent surface for adhering the tape to at least one construction element.

7. A tape for positioning construction elements, comprising:
means for indicating a first position on a first construction element from which at least one other position corresponding to at least one other construction element is measured;
means for indicating a second position at which at least a second construction element is to be positioned and aligned; and
means for attaching said first and second position indicating means to at least one construction element.

8. A tape for positioning construction elements, comprising:
means for indicating a first position on a first construction element from which at least one other position corresponding to at least one other construction element is measured;
means for indicating a second position at which at least a second construction element is to be positioned and aligned;
means for identifying at least said second construction element; and
means for attaching said first and second position indicating means and said identifying means to at least one construction element.

9. An apparatus for positioning construction elements, comprising:
a tape including:
a start indicator corresponding to a starting location on a first construction element;
a plurality of markers each indicating a position and alignment of one of a respective plurality of construction elements;
measurement data that indicates a distance of each of said plurality of markers from said start indicator; and
identification data that identifies each of said plurality of construction elements.

10. The apparatus of claim 9, wherein said tape further comprises at least one adherent surface that causes at least said tape to adhere to at least one of said plurality of construction elements.

11. The apparatus of claim 9, wherein said tape comprises a weather resistant material.

12. The apparatus of claim 11, wherein said material comprises a synthetic fiber.

13. The apparatus of claim 11, wherein said material comprises a polycarbon fiber.

14. The apparatus of claim 9, wherein said tape comprises element data that indicates hanger requirements of at least one of said plurality of construction elements.

15. The apparatus of claim 9, wherein said tape comprises data that indicates positioning of a roof opening in at least one of said plurality of construction elements.

16. The apparatus of claim 9, wherein said tape comprises roof structure information and is suitable for attachment to an overhead plate.

17. The apparatus of claim 9, wherein said tape comprises roof structure information and is suitable for attachment to a bearing face.

18. The apparatus of claim 9, wherein said tape comprises wall construction information and is suitable for attachment to a wall.

19. The apparatus of claim 9, wherein said tape includes data for identifying an entity responsible for information contained in said tape.

20. A construction method, comprising:
providing at least first and second positional indicators, said first positional indicator corresponding to a first location on a first construction element from which at least said second positional indicator corresponding to at least a second construction element is measured, and said second positional indicator corresponding to a second location at which at least said second construction element is to be positioned and aligned; and
placing said first and second positional indicators on at least one construction element.

21. The construction method of claim 20, wherein said placing step comprises attaching a tape including said first and second positional indicators to said at least one construction element.

22. The construction method of claim 21, wherein said at least one construction element to which is attached said tape comprises an overhead plate.

23. The construction method of claim 21, wherein said at least one construction element to which is attached said tape comprises a bearing face.

24. A construction method, comprising the steps of:
a step for providing at least first and second positional indicators, said first positional indicator corresponding to a first location on a first construction element from which at least said second positional indicator corresponding to at least a second construction element is measured, and said second positional indicator corresponding to a second location at which at least said second construction element is to be positioned and aligned; and
a step for placing said first and second positional indicators on at least one construction element.

25. The construction method of claim 25, wherein said step for placing said first and second positional indicators on at least one construction element comprises attaching said tape including said first and second indicators to said at least one construction element.
